(19) United States
(12) Patent Application Publication
(10) Pub. No.: US 2002/0169759 A1
(43) Pub. Date: Nov. 14, 2002

(54) Method and apparatus for graphically formulating a search query and displaying result set

(75) Inventors: Reiner Kraft, Gilroy, CA (US); Joann Ruvolo, San Jose, CA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 09/855,090

(22) Filed: May 14, 2001

(51) Int. Cl. G06F 7/00

(52) U.S. Cl. 707/3

(57) ABSTRACT

A user interface using graphical means to formulate a search query in which the method of providing the query includes the steps of selecting a visual representation of a search object (402), dropping the visual representation of a search object onto a visual representation corresponding to a domain object (404), and providing a search query in response to the dropping step (406). The system includes a graphical user interface, a graphical user interface manager (300) communicatively coupled to the graphical user interface, a query formulator (302) communicatively coupled to the graphical user interface manager (300), and responsive to the selected visual representation of a search object being dropped onto the selected visual representation of a domain object, a query initiator (304) communicatively coupled to the query formulator (302) to initiate a query request in response to the provided query, a lookup system (220) communicatively coupled to the query initiator (304) for providing a search result in response to receiving the query request, and a result set manager (306) communicatively coupled to the graphical user interface manager (300), the query initiator (304), and the lookup system (220), for providing a visual representation of a result set object to indicate the search result.

### BACKGROUND OF THE INVENTION

1. Field of the Invention

This invention generally relates to the field of formulating search queries, and more particularly relates to a user interface which uses graphical means to formulate a search query.

2. Description of Related Art

The World Wide Web (WWW) is comprised of an expansive network of interconnected computers upon which businesses, governments, groups, and individuals throughout the world maintain inter-linked computer files known as web pages. Users navigate these pages by means of computer software programs commonly known as Internet browsers. Due to the vast number of WWW sites, many web pages have a redundancy of information or share a strong likeness in either function or title. The vastness of the unstructured WWW causes users to rely primarily on Internet search engines to retrieve information or to locate businesses. These search engines use various means to determine the relevance of a user-defined search to the information retrieved.

A typical search engine possesses a user interface with a search window where the user enters an alphanumeric search expression or keywords. The search engine sifts through a database of information for the user's search terms, and returns the search results in the form of HTML pages. Each search result includes a list of individual entries that have been identified by the search engine as satisfying the users search expression. Each entry or “hit” includes a hyperlink that points to a Uniform Resource Locator (URL) location or web page. In addition to the hyperlink, certain search engine result pages include a short summary or abstract that describes the content of the URL location. Other information may also be returned as part of a search result in response to a user's search request.

Although search engines have made tremendous strides at improvement in recent years, the user interface can still be very complicated to use. Primarily, these interfaces require a certain degree of literacy and spelling ability in order for the user to achieve a desired result. Additionally, for complex searches, users may even be called upon to employ Boolean operators. As a further complication, different search engines may employ drastically varying user interfaces, which often serve to further confuse users.

Therefore a need exists to overcome the problems with the prior art as discussed above, and particularly for a user interface that simplifies user's task of formulating search queries such as via a GUI to formulate a search query and to display a corresponding result set.

### SUMMARY OF THE INVENTION

According to a preferred embodiment of the present invention, a method provides a query in a system. The method comprises the steps of selecting at least one visual representation of a search object; dropping the at least one visual representation of the search object onto at least one visual representation corresponding to a domain object; and in response to the dropping step, providing a query. This preferred method advantageously allows a user to formulate a search query by using graphical representations of objects. Further, the method, in response to a search using the search query, can provide at least one visual representation of a result set object.

According to a preferred embodiment of the present invention, a system comprises a graphical user interface; a graphical user interface manager communicatively coupled to the graphical user interface; a query formulator, communicatively coupled to the graphical user interface manager, and responsive to a selected at least one visual representation of a search object being dropped onto at least one selected visual representation of a domain object to provide a query; a query initiator, communicatively coupled to the query formulator to initiate a query request in response to the provided query; a lookup system, communicatively coupled to the query initiator, for providing a search result in response to receiving the query request; and a result set manager, communicatively coupled to the graphical user interface manager, to the query initiator, and to the lookup system, for providing a visual representation of a result set object to indicate the search result.

### BRIEF DESCRIPTION OF THE DRAWINGS

FIG. 1 is a block diagram illustrating a graphical search system in accordance with a preferred embodiment of the present invention.

FIG. 2 is a more detailed block diagram showing a computer system in the system of FIG. 1, according to a preferred embodiment of the present invention.

FIG. 3 is another more detailed block diagram showing a visual search query application in the system of FIG. 1, according to a preferred embodiment of the present invention.

FIG. 4 is an operational flow diagram illustrating an exemplary operational sequence for the system of FIG. 1, according to a preferred embodiment of the present invention.

FIG. 5 is an exemplary graphical user interface illustrating a selection sequence for formulating a search query according to a preferred embodiment of the present invention.

### DESCRIPTION OF THE PREFERRED EMBODIMENTS

The present invention, according to a preferred embodiment, overcomes problems with the prior art by allowing the user to formulate a search engine query by using graphical representations of objects. The user begins the search by selecting the graphical representation of a search object which visually represents the logical object of the search query. For example, assuming it was tennis, the user would click upon a tennis racket. The next step could involve the user dragging the search object selected and dropping it onto a graphical representation of a domain object. Domain objects are graphical representations of a target domain, which provides context to the search. For example, dropping the search object (tennis racket) onto a domain object which visually depicts two students in a graduation ceremony would indicate that the user is looking for tennis lessons. The program will then initialize a search for tennis lessons which could occur in locations such as a database system, or a remote Internet site. As a result of this search, the program will produce a result set object, which is a visual representation of the matches found from the search query. In this example, a result object depicting a school would be returned to represent the sites that give tennis lessons.

A significant aspect of this invention is its visual representation of search objects. In general, visual interfaces are more intuitive than text based interfaces. Also “dropping” a search object onto a target domain provides a much more powerful visual. Visuals, for the most part, are language independent. Without words, there is little need for a translation, for example, national language support. For example, a tennis racket looks the same in the United States as it does in Germany. Visual interfaces can also support a larger population of users including those people with language difficulties, spelling challenges, and illiterates. It also provides a consistent user interface across search engines.

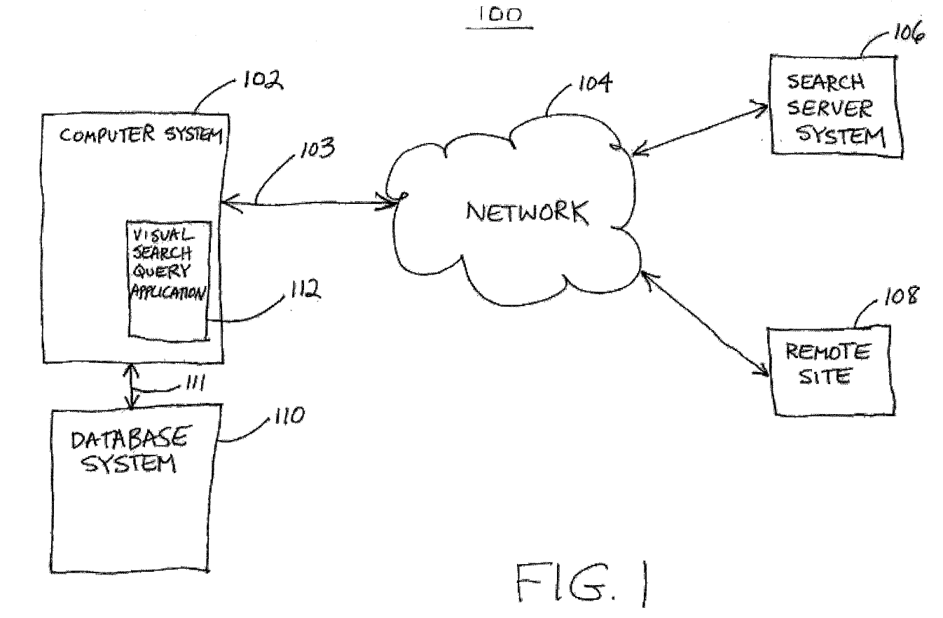

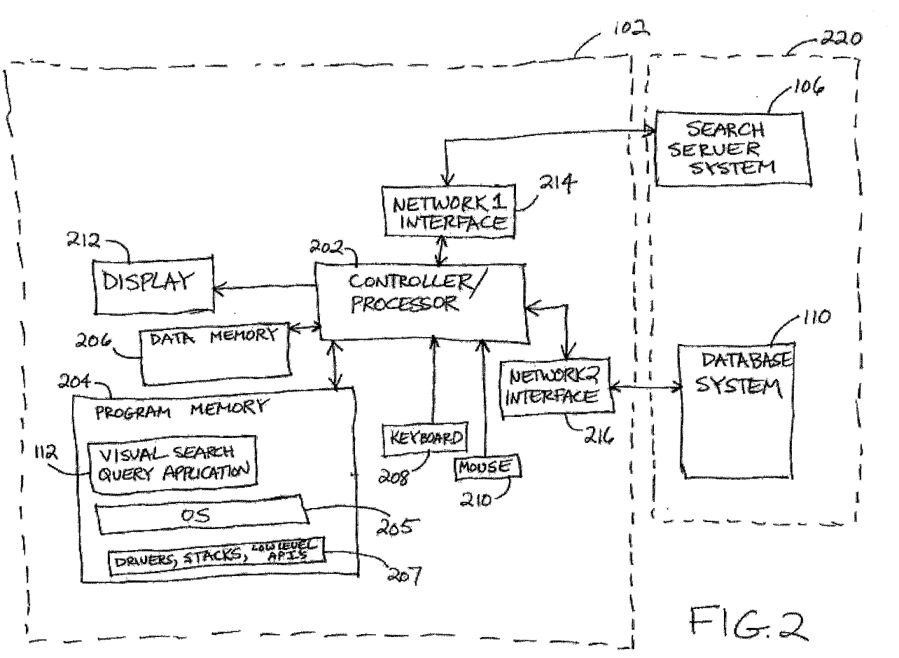

FIGS. 1 and 2 illustrate an exemplary graphical search system 100 according to a preferred embodiment of the present invention. The graphical search system 100 includes a computer system 102, having a visual search query application 112. Computer system 102 may be communicatively coupled with a database system 110, via a local area network communication link 111, comprising at least one of a wired communication link and a wireless communication link. Additionally, computer system 102 may also be communicatively coupled with a wide area network 104 such as the Internet, a wired, wireless, or a combination of wired and wireless communication links via a wide area network communication link 103. Furthermore, wide area network 104 may be communicatively coupled to a search server system 106, which may include one or more Internet search engines. Also shown is a remote site 108, which may include various remote Internet sites, that are communicatively coupled to the wide area network 104.

Computer system 102 includes controller/processor 202 (shown in FIG. 2) which processes instructions, performs calculations, and manages the flow of information through the computer system 102. Additionally, controller/processor 202 is communicatively coupled with program memory 204. Included within program memory 204 are visual search query application 112 (which will be discussed later in greater detail), operating system platform 205, and glue software 207. The operating system platform 205 manages resources, such as the data stored in data memory 206, the scheduling of tasks, and processes the operation of the visual search query application 112 in the program memory 204. The operating system platform 205 also manages a graphical display interface 212, a user input interface (not shown) that receives inputs from the keyboard 208 and the mouse 210, and communication network interfaces 214, 216 for communicating with the network links 103, 111 respectively. Additionally, the operating system platform 205 also manages many other basic tasks of the computer system 102 in a manner well known to those of ordinary skill in the art.

Glue software 207 may include drivers, stacks, and low level application programming interfaces (API's) and provides basic functional components for use by the operating system platform 205 and by compatible applications that run on the operating system platform 205 for managing communications with resources and processes in the computing system 102.

Network interfaces 214, 216 communicative couple the controller/processor 202 in the computer system 102 with a lookup system 220. The lookup system 220, according to one alternative embodiment, comprises the remote search server system 106. According to a second alternative embodiment, a lookup system 220 may comprise a local database system 110. Note that as shown the database system 110 is shown on a local area network. Alternatively, the database system 110 may be located in the computer system 102 resident in program memory 204 and managing data in a database memory (not shown) as part of the data memory 206.

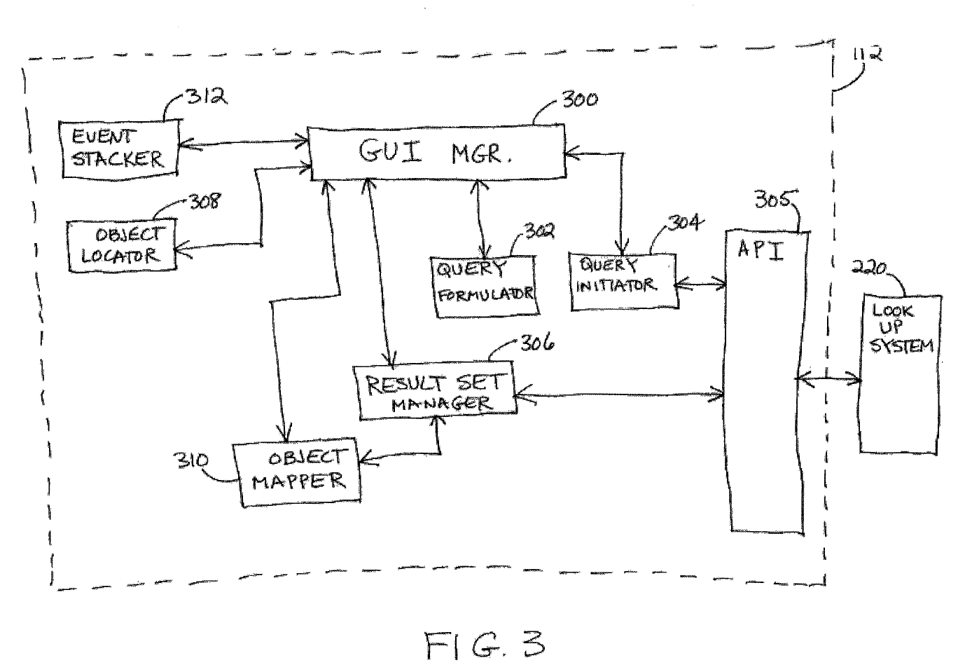

FIG. 3 illustrates the exemplary visual search query application 112 according to a preferred embodiment of the present invention. The graphical user interface/event manager 300 is structured to receive all GUI/event manager 300 events, such as mouse movements, keyboard inputs, drag and drop actions, user selections, and updates to the display 212. The user can access objects via the GUI/event manager 300 and manipulate them in various ways. The user can group objects in any of a number of ways, including linking or connecting them together, dragging one on top of another, and enclosing them within a bound area shown on the display 212. The user can also associate properties to an object, for example, the object context and whether an object is negated, for example “not tennis”. GUI/event manager 300 is also structured to receive match records, from the result set manager 306, which will be discussed subsequently, representing the result set for a user initiated search request. These results are then displayed to the user via the display 212. GUI/event manager 300 is communicatively coupled with object locator 308, object mapper 310, event stacker 312, query formulator 302, query initiator 304, and result set manager 306.

The GUI/event manager 300 is communicatively coupled with the object locator 308 which provides the access to the object repositories that contain the search objects, domain objects, and result set objects. Access to object locator 308 is via the GUI/event manager 300 on behalf of a user traversing the respective object repositories' object templates and when displaying search results.

Object mapper 310 provides a two way mapping between object identifiers and the objects themselves. Associated with the object are string representations of an object, for example “tennis racket”. Natural Language Support can also be supported by maintaining mappings to the various languages supported. Object mapper 310 is in communication with the query formulator 302, which will be discussed subsequently, to map an object selected by the user via the GUI/event manager 300 to its corresponding object identifier and string representation. Object mapper 310 is also called from the result set manager 306 to map an object identifier to its corresponding object.

Event stacker 312 is used to compile and define a user search request stack. The event stacker 312 is called from the GUI/event manager 300 on a GUI event triggered by the user such as a mouse or keyboard command. There are four input parameters associated with the event stacker 312. The first is a source object ID, which identifies the object that is the source of the operation. The second is a target object ID, which identifies the object that is the target of the operation. The third is an operator ID, which identifies the operator between the source and target objects. Example operators can include the Boolean AND, OR, and NOT. The fourth is the result object ID, which identifies the object that results from the source object operating on the result object. Event Stacker 312 maintains a search request stack for each user, which contains the history all GUI events triggered by the user in defining his search request. The history resides on a stack visually in LIFO (last in, first out) order. Each stack entry contains four fields, one for each of the input parameters.

After the event stacker 312 has finished defining the search request, the query formulator 302 is invoked from the GUI/event manager 300 when the user has finished defining the search request. Query formulator 302 preferably builds a text search query from the user's search request stack. Note that it is possible for subsequent stack entries to negate previous entries. Therefore, the stack history is maintained. The final text search query is the result of unfolding the user's stack entries in a time order (last in, first out), which is then conformed to the application programming interface (API) 305 designated for communication with the lookup system 220. Some rules in formulating the text search query from the request stack may preferably include that the stack be in infix order, operation ignored on first stack entry, parenthesis added on each new entry, parenthesis added around string representation of multi-word object, and string representation of object dependent upon context of object.

After a query is formulated, query initiator 304 is invoked from the GUI/event manager 300 to initiate the user's search request. Input to the query initiator 304 can preferably be a text based search query, that was built by the query formulator 302. The preferably text based search query is sent first to the Application Programming Interface 305 (API), and then to the lookup system 220 which has been discussed previously.

Finally, after the search has been executed by the lookup system 220, the result set manager 306 then receives the incoming results from the lookup system 220, which it correlates to the outgoing search requests. The result set for each search request may contain 0 or more match records, which preferably contain a hypertext link for representing the match and a mapping identifier. This mapping identifier is used as input to the object mapper 310 to find its corresponding object. The match record is updated with the corresponding object.

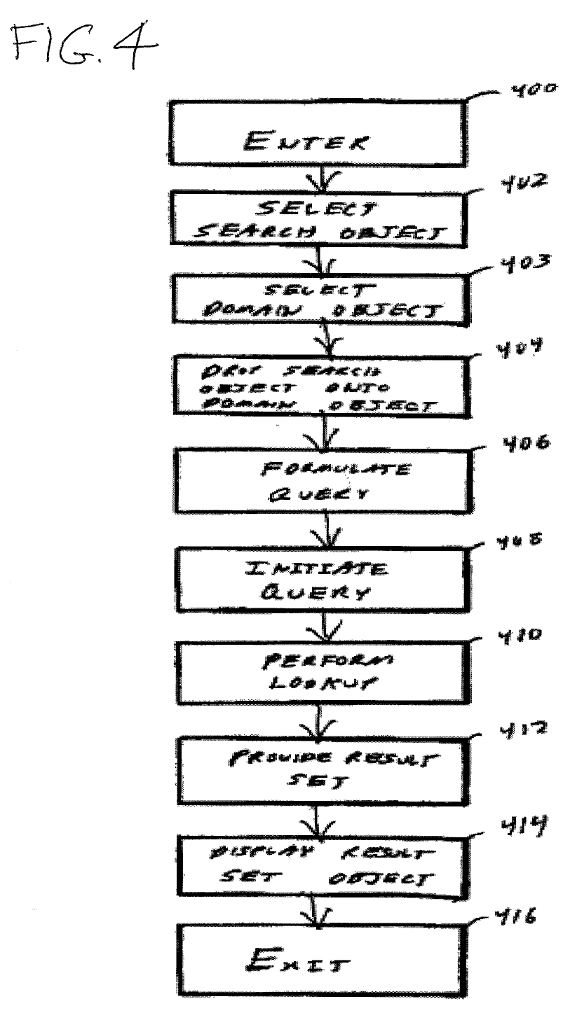

FIG. 4 is an operational flow diagram illustrating an exemplary operational sequence for the system of FIG. 1. The system enters the sequence at step 400, wherein a user is communicating via a user interface with the computer system 102. A graphical display, such as the display 212, displays a group of search objects to the user. Search objects are the visual representations of the items being sought. The search objects may be stored persistently on a disk storage device, such as part of data memory 206, and the search objects are preferably organized hierarchically into templates. For example, the map template may contain templates for Europe, North America, and South America. The Europe template could further contain the search objects for Italy, France, and Germany.

The user operates the user interface, such as the mouse 210 and/or keyboard 208, to select the search object, at step 402, which visually represents the logical object of the desired search query, by using means such as clicking a mouse button when the cursor is located onto the at least one search object, or selecting the at least one search object with a keyboard movement.

The user then selects a domain object 403. Domain objects are the visual representations of the target domain. A domain object provides context to a search. Domain objects may also be stored persistently on a disk storage device, such as in part of data memory 206, and organized hierarchically into templates. Each domain object, in this example, is matched to its verb. For example, a charge card maps to buy. The domain object may be dragged onto a palette, which may be represented by an area defined by graphical boundaries on the user display 212.

The user then drops the search object selected onto the domain object, at step 404. This may be preferably accomplished by dragging the search object across the user interface, e.g. the display 212, once again using a mouse 210 or keyboard 208, and placing the search object on top of the domain object.

Once this step is completed, the application 112 formulates a query, at step 406. In order to accomplish this, the user's above-mentioned selections are compiled and defined into a search request. A query is then created, preferably as a text search string.

At this time, a query is initiated, at step 408, whereupon the above mentioned search string is sent out to perform its search function, preferably to a lookup system 220.

A lookup is then performed, at step 410. The lookup uses the formulated query, and may search for results in a variety of different locations, including at least one database system.

Once the search is exhausted, the result set is provided, at step 412. The result set includes all matches found during the lookup. These may include a compilation of information from a database and/or from web page locations.

Finally, the result set object is displayed to the user via the display 212, at step 414. Then, the system 102 exits the operational sequence at step 416. Result set objects are visual representations of the above-mentioned matches found from the lookup. They may also be stored persistently on a disk storage device and organized hierarchically into templates, as discussed above. It is important to note at this point that although the search, domain, and result set objects are described separately, they can be used interchangeably. The interpretation of the objects is dependent upon how they are used. For example, a map of Italy can be used as a search object when wanting to learn Italian; it can be used as a domain object when seeking cathedrals in Italy; and it can be used as a result set object when indicating a romantic vacation spot.

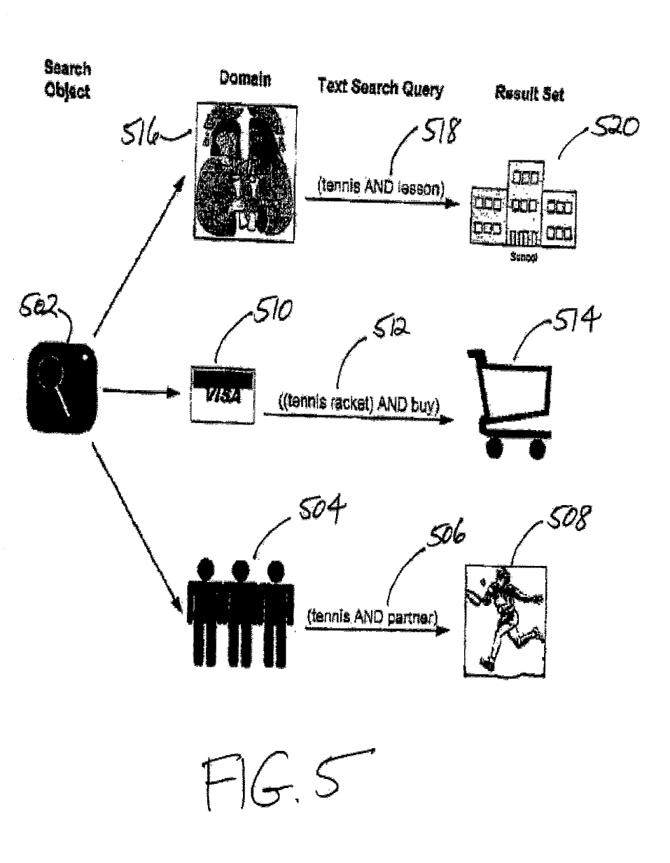

Referring to FIG. 5, according to one exemplary scenario, a user employs the visual search query application 112 in order to search for a tennis partner. This is illustrated by traversing displayed objects along arrows leading to the tennis player object.

Because the subject of the users' query involves tennis, the user would select a search object which visually depicts tennis. In this case, such a search object may be preferably represented in the graphical depiction of a tennis racquet 502.

After selecting the search object, the user would need to select a domain object. The domain object would need to add context to the users' search, and in this case would have to represent partner. Here, a selection could be the graphical depiction of multiple persons 504. Therefore, by dragging the graphical depiction of the tennis racquet 502 onto the graphical depiction of the multiple persons 504, the user would have defined a search request for tennis partner.

That search request would then be preferably translated into a text search query 506 and then sent to the preferable search site. After the search was exhausted, the result set is returned to the user. In this case it is a graphical representation of a person playing tennis 508. By accessing this result set, the user would be provided with a compilation of information or links regarding tennis partners.

In another exemplary scenario, a user employs the visual search query application 112 in order to purchase a tennis racquet. This is illustrated by traversing displayed objects along arrows leading to the shopping cart object.

Because the user's query again involves tennis, the user selects the search object preferably represented in the graphical representation of a tennis racquet 502.

After selecting the search object, the user would need to add context to the search, and in this case would have to represent a purchase. Here, a selection could be the graphical depiction of a credit card 510. Therefore, by dragging the graphical depiction of the tennis racquet 502 onto the graphical depiction of the credit card 510, the user would have defined a search request for a tennis racquet purchase.

That search request would then be preferably translated into a text search query 512 and then sent to the preferable search site. After the search was exhausted, the result set is returned to the user. In this case it is a graphical representation of a shopping cart 514. By accessing this result set, the user would be provided with a compilation of information or links regarding possible tennis racquet purchases.

In yet another exemplary scenario, a user employs the visual search query application 112 in order to search for tennis lessons. This is illustrated by traversing displayed objects along arrows leading to the school object.

Because the user's query once again involves tennis, the user would select the search object preferably represented in the graphical representation of a tennis racquet 502.

After selecting the search object, the user would need to add context to the search, and in this case would have to represent a lesson. Here, a selection could be the graphical depiction of a graduation 516. Therefore, by dragging the graphical depiction of the tennis racquet 502 onto the graphical depiction of the graduation 516, the user would have defined a search request for tennis lessons.

That search request would then be preferably translated into a text search query 518 and then sent to the preferable search site. After the search was exhausted, the result set is returned to the user. In this case it is a graphical representation of a school 520. By accessing this result set, the user would be provided with a compilation of information or links regarding tennis lessons.

The present invention can be realized in hardware, software, or a combination of hardware and software. A controller, as illustrated in FIG. 2, and/or in a disk drive system as illustrated in FIG. 2, according to the preferred embodiments of the present invention, can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context means any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of providing a query, the method comprising the steps of:
selecting at least one visual representation of a search object;
dropping the at least one visual representation of the search object onto at least one visual representation corresponding to a domain object; and
in response to the dropping step, providing a query.

2. The method of claim 1, further comprising the steps of:
in response to the provided query, searching at least one collection of information; and
in response to the search of the at least one collection of information, providing at least one visual representation of a result set object.

3. The method of claim 2 wherein the visual representation of the result set object indicates whether at least one match was found as a result of the search.

4. The method of claim 1, wherein the visual representation of the search object comprises a visual representation of an item sought.

5. The method of claim 1, wherein the visual representation of the domain object comprises a visual representation of an action to indicate a context for a search.

6. The method of claim 1, further comprising the step of formulating a text search query.

7. The method of claim 6, further comprising the step of sending the text search query to at least one search engine.

8. The method of claim 6, further comprising the step of sending the text search query to at least one pre-collected database repository.

9. A system comprising:
a graphical user interface;
a graphical user interface manager communicatively coupled to the graphical user interface;
a query formulator, communicatively coupled to the graphical user interface manager, and responsive to a selected at least one visual representation of a search object being dropped onto at least one selected visual representation of a domain object to provide a query;
a query initiator, communicatively coupled to the query formulator to initiate a query request in response to the provided query;
a lookup system, communicatively coupled to the query initiator, for providing a search result in response to receiving the query request; and
a result set manager, communicatively coupled to the graphical user interface manager, to the query initiator, and to the lookup system, for providing a visual representation of a result set object to indicate the search result.

10. The system of claim 9, wherein the graphical user interface manager is structured to receive at least one user initiated command.

11. The system of claim 9, wherein the lookup system provides access to at least one object repository.

12. The system of claim 9, wherein the search result provided from the lookup system comprises an object identifier for retrieving an object.

13. The system of claim 9, wherein the graphical user interface manager comprises an event stacker structured to maintain a query stack.

14. The system of claim 13, wherein the event stacker is further structured to associate items in the query stack with pending query requests.

15. The system of claim 9, wherein the query formulator is structured to provide a text search query.

16. The system of claim 9, wherein the query Initiator is structured to initiate a query request comprising an object search request.

17. The system of claim 9, wherein the result set manager is structured to correlate an at least one search result to an at least one query request.

18. The system of claim 9, further comprising an object mapper communicatively coupled to the graphical user interface manager, the query formulator, and the result set manager.

19. The system of claim 18, wherein the object mapper is further structured to map a selected object to a corresponding object identifier and a string representation.

20. A computer readable medium including computer instructions for driving a graphical user interface, the computer instructions comprising instructions for:
selecting at least one visual representation of a search object;
dropping the at least one visual representation of the search object onto at least one visual representation corresponding to a domain object; and
in response to the dropping step, providing a query.

21. The computer readable medium of claim 20, wherein the computer instructions further comprise the instructions for:
in response to the provided query, searching at least one collection of information; and
in response to the search of the at least one collection of information,
providing at least one visual representation of a result set object.

22. An apparatus comprising:
a graphical user interface;
a visual search query application;
an interface communicatively coupled to the visual search query application; and
a search base interface communicatively coupled with the visual search query application and the application programming interface for:
selecting at least one visual representation of a search object in the graphical user interface;
dropping the at least one visual representation of the search object onto at least one visual representation of a domain object; and
in response to dropping the at least one visual representation of the search object onto at least one visual representation of a domain object, providing a query request to the search base interface.

23. The apparatus of claim 22, wherein the interface communicatively coupled to the visual search query application further comprises an application programming interface.

24. The apparatus of claim 22, wherein the search base interface sends the query request to a database repository.

25. The apparatus of claim 24, wherein the data base repository is pre-collected.

26. The apparatus of claim 22, wherein the search base interface sends the query request to at least one search engine.

27. The apparatus of claim 26, wherein the at least one search engine is structured to search the world wide web.
